(19) United States
(12) Patent Application Publication
(10) Pub. No.: US 2010/0190144 A1
(43) Pub. Date: Jul. 29, 2010

(54) Method, System and Computer Program Product for Studying for a Multiple-Choice Exam

(76) Inventor: Mary K. Miller, Sacramento, CA (US)

Correspondence Address: Mary K Miller MD, 571 Ashton Park Lane, Sacramento, CA, 95864, US

(21) Appl. No.: 12/491,234

(22) Filed: Jun. 25, 2009

Related U.S. Application Data
(60) Provisional application No. 61/147,463, filed on Jan. 26, 2009.

(51) Int. Cl. G09B 7/00; G09B 3/00

(52) U.S. Cl. 434/323; 434/322

(57) ABSTRACT

A variety of techniques for a method, system and computer program product for studying for a multiple-choice exam are presented. The method for studying for a multiple-choice exam includes steps of obtaining access to a bank of review questions for the exam. A set of N number of questions is accessed from the bank. A user answers the N number of questions during a fixed time period. The user records information about incorrectly answered questions in an abbreviated format. The user reviews the recorded information. Meetings with the user and an exam coach are conducted on a periodic basis. The steps of accessing, answering, recording, reviewing, and meeting are repeated until all review questions have been answered.

### CROSS-REFERENCE TO RELATED APPLICATIONS

The present Utility patent application claims priority benefit of the U.S. provisional application for patent Ser. No. 61/147,463 filed on 26 Jan. 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to study methods. More particularly, the invention relates to a study method for pre-professional students, enrolled students or graduates of professional schools to pass multiple-choice exams.

### BACKGROUND OF THE INVENTION

The present invention provides a study method for test takers to study for multiple-choice exams. Many people have difficulty taking multiple-choice exams because of various reasons. Some reasons given by test takers as to why they dislike multiple-choice exams are as follows. They run out of time while taking the exam. They do not understand the question(s). They do not believe that the correct answer is listed as one of the choices. They studied the wrong things. They become distracted, anxious or fatigued. Reasons cited by experts on why test takers do not do well on multiple-choice exams include the following. The test taker may be overconfident. The test writer may try to trick the test taker. The test taker may be affected by time pressures. The test taker cannot bluff answers on a multiple-choice exam. A broader range of topics can be covered quickly in a multiple-choice exam, and a greater level of detail may be asked in multiple-choice questions. Multiple-choice questions can be difficult for the exam writer to write. Finally, in a typical multiple-choice exam, the content is shuffled. For example, without limitation, in a medical exam, biochemistry may be mixed in with pharmacology and pathology. It is therefore an objective of the present invention to provide an improved method of studying for multiple-choice exams that helps test takers prepare for difficulties specific to multiple-choice questions

In view of the foregoing, there is a need for improved techniques for studying for multiple-choice exams that adequately prepare the test taker for the exam subject and for the difficulties of the multiple-choice format.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an overview of an exemplary study method for a multiple-choice exam, in accordance with an embodiment of the present invention;

FIG. 2 is a flowchart illustrating an exemplary study method using online question banks, in accordance with an embodiment of the present invention;

FIG. 3 is a flowchart illustrating an exemplary study method using review question books, in accordance with an embodiment of the present invention;

FIG. 4 is a flowchart illustrating an exemplary method for creating and using a F.A.C.T.O.I.D.® book, in accordance with an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of techniques for a method, system and computer program product for studying for a multiple-choice exam are described.

In one embodiment a method for studying for a multiple-choice exam is presented. The method includes steps for obtaining access to a bank of review questions, steps for accessing a set of questions from the bank, steps for answering the questions of the set during a fixed time period, steps for recording information about incorrectly answered questions, steps for reviewing the recorded information, steps for meeting with an exam coach and steps for repeating the steps for accessing, answering, recording, reviewing and meeting until all review questions have been answered. Another embodiment further includes steps for, after all review questions have been answered, repeating the steps of accessing, answering, recording, reviewing and meeting until all review questions have been answered an additional time.

In another embodiment a method for studying for a multiple-choice exam is presented. The method includes steps of obtaining access to a bank of review questions for the exam, accessing a set of N number of questions from the bank, answering the N number of questions during a fixed time period, recording information about incorrectly answered questions in an abbreviated format, reviewing the recorded information, meeting with an exam coach on a periodic basis and repeating the steps of accessing, answering, recording, reviewing, and meeting until all review questions have been answered. Another embodiment further includes the step of after all review questions have been answered, repeating the steps of accessing, recording reviewing and meeting until all review questions have been answered an additional time. Yet another embodiment further includes incrementing the N number of questions until a number of questions equals a desired number. In another embodiment the review questions include mixed topics. In yet another embodiment the information is recorded in at least one book. In various other embodiments the information further includes notes pertaining to topics of the incorrectly answered questions and the information further includes a summary for a specific topic of repeatedly incorrectly answered questions. In another embodiment the bank of review questions is obtained using a computing device. In yet another embodiment the bank of review questions is obtained using at least one review book. In still another embodiment the bank of review questions is obtained using a computing device and at least one review book.

In another embodiment a system for studying for a multiple-choice exam is presented. The system includes a bank of review questions for the exam, the bank including a plurality of sets of questions that are accessed, one at a time, by a user answering questions in an accessed set during a determined time period. A recording device records information about incorrectly answered questions in an abbreviated format where the user reviews the recorded information. An exam coach meets with the user on a periodic basis. In another embodiment, all of the review questions are answered by the user a plurality of times. In yet another embodiment the review questions include mixed topics. In still another embodiment the recording device includes at least one book. In various other embodiments the information further includes notes pertaining to topics of the incorrectly answered questions and the information further includes a summary for a specific topic of repeatedly incorrectly answered questions. In another embodiment the bank of review questions is accessed using a computing device. In yet another embodiment the bank of review questions is accessed using at least one review book. In still another embodiment the bank of review questions is accessed using a computing device and at least one review book.

In another embodiment a system for studying for a multiple-choice exam is presented. The system includes means for accessing a plurality of sets of questions, one at a time, by a user answering questions in an accessed set during a determined time period, means for recording information about incorrectly answered questions in an abbreviated format where the user reviews the recorded information and means for meeting with an exam coach on a periodic basis. In another embodiment the questions include mixed topics. In yet other embodiments the information further includes notes pertaining to topics of the incorrectly answered questions and the information further includes a summary for a specific topic of repeatedly incorrectly answered questions.

In another embodiment a computer program product for studying for a multiple-choice exam is presented. The computer program product includes computer program code for obtaining access to a bank of review questions for the exam. Computer program code accesses a set of questions from the bank. Computer program code determines incorrectly answered questions in the set during a fixed time period. Computer program code records information about the incorrectly answered questions. Computer program code is provided for reviewing the recorded information. Computer program code is provided for meeting with an exam coach on a periodic basis. Computer program code is provided for repeating the accessing, determining, recording, reviewing and meeting until all review questions have been answered. A computer-readable medium stores the computer program code. Another embodiment further includes computer program code for, after all review questions have been answered, repeating the accessing, determining, recording, reviewing and meeting until all review questions have been answered an additional time.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Preferred embodiments of the present invention provide a study method for pre-professional students, enrolled students or graduates of professional schools to pass multiple-choice exams using online question banks and/or review question books. Preferred embodiments are directed toward studying for professional exams such as, but not limited to, the United States Medical Licensing Exam (USMLE), Bar exams, exams to become a certified public accountant (CPA), etc. However, embodiments of the present invention may be adapted to study for practically any type of multiple-choice exam. In preferred embodiments the user may be required to sign up for online question bank subscription or to obtain review question books or in some cases both. The selection of online questions versus review question books is dependent on the user's anticipated exam type (i.e., computer-based testing versus written testing) or learning or studying preference. In preferred embodiments, the user answers timed mixed question sets, writes up missed questions in a frequently asked concepts to own in depth (F.A.C.T.O.I.D.® book, reviews the F.A.C.T.O.I.D.® book(s) frequently, and meets with a faculty coach. After the completion of the first pass through the online question bank or the review question book(s) in preferred embodiments, the online question bank and/or review question book(s) are restarted. The user continues to answer timed mixed question sets, write up missed questions in a F.A.C.T.O.I.D.® book; review the F.A.C.T.O.I.D.® book(s) frequently, and meet with a faculty coach. In some applications of the present embodiment, students can “type” some of their factoid book notes on smart phones directly or used their computer for note taking and then transfer them to their smart phone or equivalent device for “on-the-go” review.

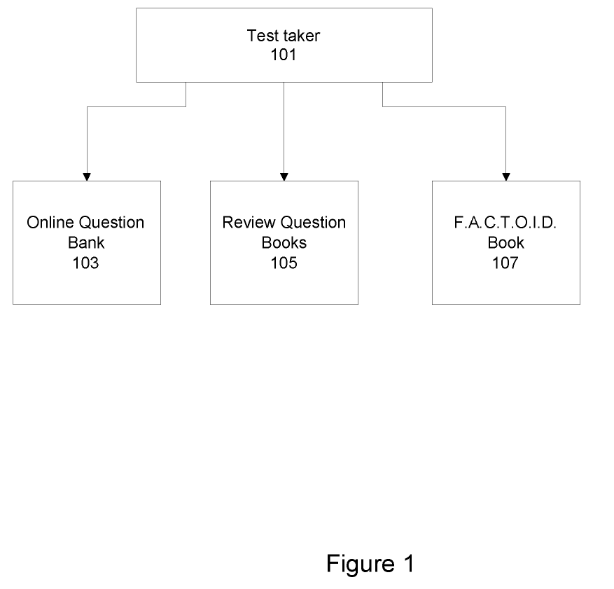

FIG. 1 is a block diagram illustrating an overview of an exemplary study method for a multiple-choice exam, in accordance with an embodiment of the present invention. In the present embodiment, a test taker 101 can interact with an online question bank 103, review question books 105 and a F.A.C.T.O.I.D.® book 107. Test taker 101 may choose to use online question bank 103 if the test for which he is studying will be administered on a computer and may use review question books 105 if the test will be administered on paper. Test taker 101 may also choose to use online question bank 103, review question books 105 or both based on his learning or studying preferences. F.A.C.T.O.I.D.® book 107 is a record of the questions missed by test taker 101 when using online question bank 103 or review question books 105. Reviewing F.A.C.T.O.I.D.® book 107 enables test taker 101 to focus on test content that he has not yet fully grasped.

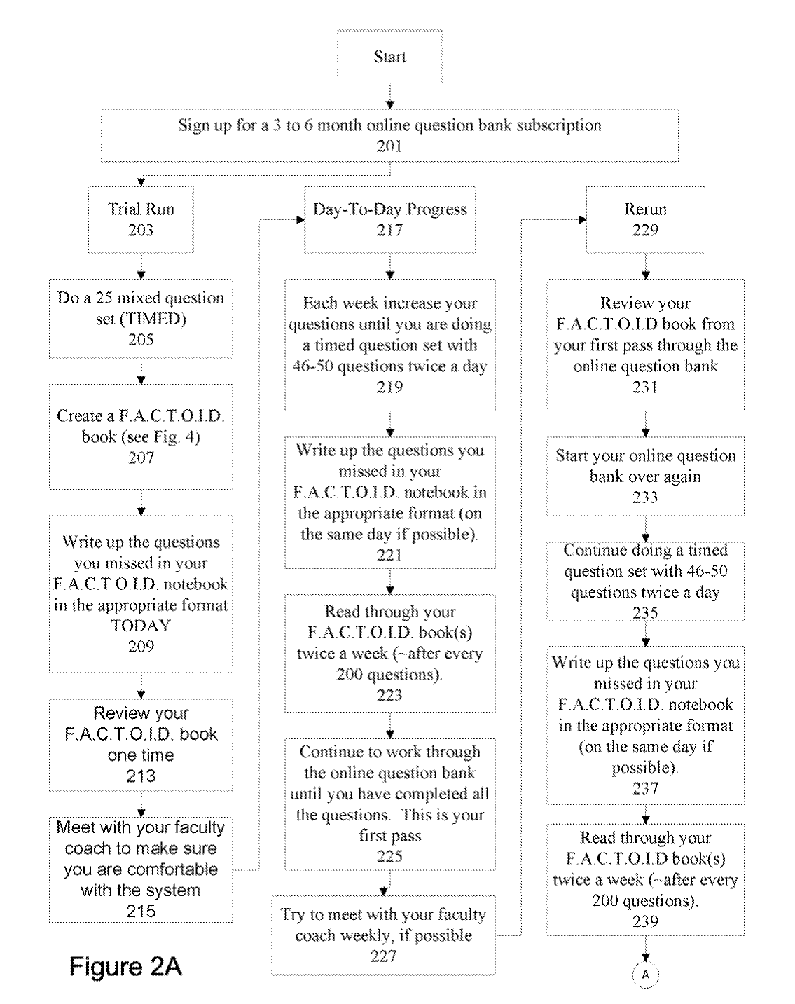

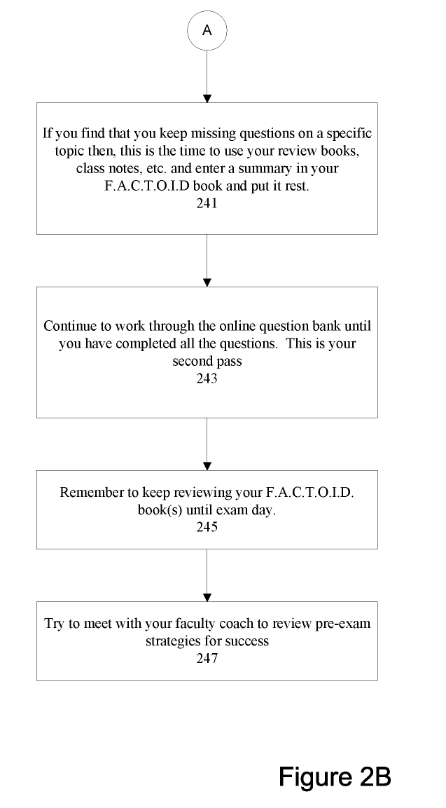

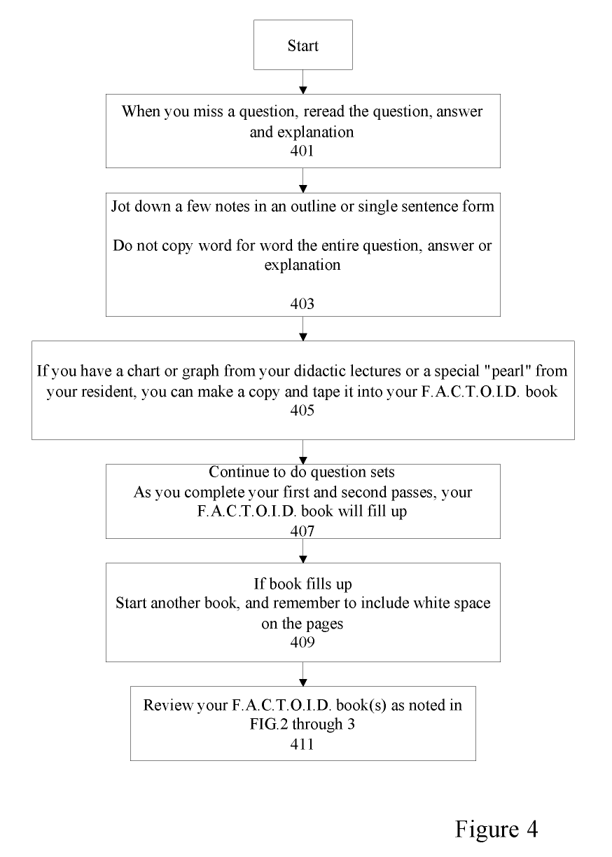

FIG. 2 is a flowchart illustrating an exemplary study method using online question banks, in accordance with an embodiment of the present invention. In the present embodiment, the method begins at step 201 where the user signs up for a 3 to 6 month online question bank subscription. In alternate embodiments the duration of the subscription may be longer or shorter. In other alternate embodiments, the question bank may be from a source other than the Internet such as, but not limited to, a non-Internet based database, a computer disk, a downloadable file, etc. In the present embodiment, the user then performs a trial run starting at step 203. For the trial run, the user answers a mixed question set with 25 questions in step 205. This step is timed to create test conditions. For example, without limitation, the user may have 30 minutes to answer all 25 questions (approximately 1-1.5 minutes/question). In alternate embodiments the trial run may comprise more or fewer questions, and in some alternate embodiments, the trial run may not be timed. In step 207 of the present embodiment, the user creates a F.A.C.T.O.I.D.® book, as described by way of example in accordance with FIG. 4. Then, in step 209, the user writes up the questions missed in step 207 in the F.A.C.T.O.I.D.® book in the appropriate format, as described by way of example in accordance with FIG. 4. The user should ignore the score on this trial run as the score is not important at this point in the method. However, in some cases the user may want to look at this score so that he can track his progress later in the method. In step 213 the user reviews the F.A.C.T.O.I.D.® book one time preferably on the same day that step 207 is performed. The user meets with a faculty coach in step 215 to make sure the user is comfortable with the system.

Then the method proceeds to step 217, which begins the day-to-day progress of the method. In step 219 the user answers a question set twice a day, and each week the user increases the number of questions answered in these question sets until the user is doing a timed question set with 46-50 questions twice a day. This is the preferred range of questions to complete, and in alternate embodiments the user may perform more or fewer question sets a day with more or fewer questions. Some students do 75-100 questions or more per question set. The range of 46-50 questions is similar to the question blocks found on the formal examinations. However the number of questions per set is subject to change depending on the formal test organization and their governing body. In the present embodiment, the goal of performing these question sets is to get through the online question bank as quickly as possible. However, if the user has ample time to study or a limited time to study per day, the quick completion of the question bank may not be a priority. In step 221 the user writes up the questions missed while answering the question sets in the F.A.C.T.O.I.D.® book in the appropriate format. This step is preferably performed on the same day that the question sets are answered if possible. The user reads through the F.A.C.T.O.I.D.® book(s) twice a week or about after every 200 questions answered in question sets in step 223. In alternate embodiments, the user may read through the F.A.C.T.O.I.D. book more or less frequently. In the present embodiment, the user continues to work through the online question bank in step 225 until the user has completed all of the questions in the bank. This completes the user's first pass. In step 227 the user tries to meet with the faculty coach weekly, if possible.

In step 229 the method begins a rerun of the online question bank. In step 231 the user reviews the F.A.C.T.O.I.D.® book from the first pass through the online question bank. Then, in step 233, the user restarts the online question bank from the beginning. The user continues doing timed question sets with 46-50 questions twice a day in step 235 and writes up the questions missed in the F.A.C.T.O.I.D.® book in the appropriate format on the same day if possible in step 237. At this point the user should be missing fewer questions and therefore not having to write up as many questions in the F.A.C.T.O.I.D.® book. This is the preferred range of questions to complete, and in alternate embodiments the user may perform more or fewer question sets a day with more or fewer questions. In step 239 of the present embodiment, the user reads through the F.A.C.T.O.I.D.® book(s) about twice a week or about after every 200 questions. In alternate embodiments, the user may read through the F.A.C.T.O.I.D.® book more or less frequently. In the present embodiment, if the user finds that he continues to miss questions on a specific topic, the user uses review books, class notes, etc. and enters a summary of the topic in the F.A.C.T.O.I.D.® book in step 241. This step may be skipped if the user does not seem to be missing questions on a specific topic regularly. The user continues to work through the online question bank in step 243 until all of the questions have been completed. This is the second pass. If the user is running out of time and cannot work through the entire question bank a second time in step 243, the user should preferably at least try to get through the previously missed questions from the first pass and write up missed questions. The user continues to review the F.A.C.T.O.I.D. book(s) until exam day in step 245 and tries to meet with the faculty coach to review pre-exam strategies for success in step 247.

In alternate embodiments, the method may be implemented as an online or self-contained computer program. The question bank may be from a source such as, but not limited to, an Internet based database, a non-Internet based database, a computer disk, a downloadable file, etc. The F.A.C.T.O.I.D.® book, as described by way of example in accordance with FIG. 4, could be implemented as an electronic book stored on a local computer or on a network site. This would provide users that are comfortable using computers a contained place for questions and notes. This would also provide for additional features such as but not limited to, statistics regarding performance in doing the timed question sets. Additional alternate embodiments may also implement the meetings with the faculty coach as online meetings using network connections such as, but not limited to, instant messaging, online chats, social networking sites, email, etc.

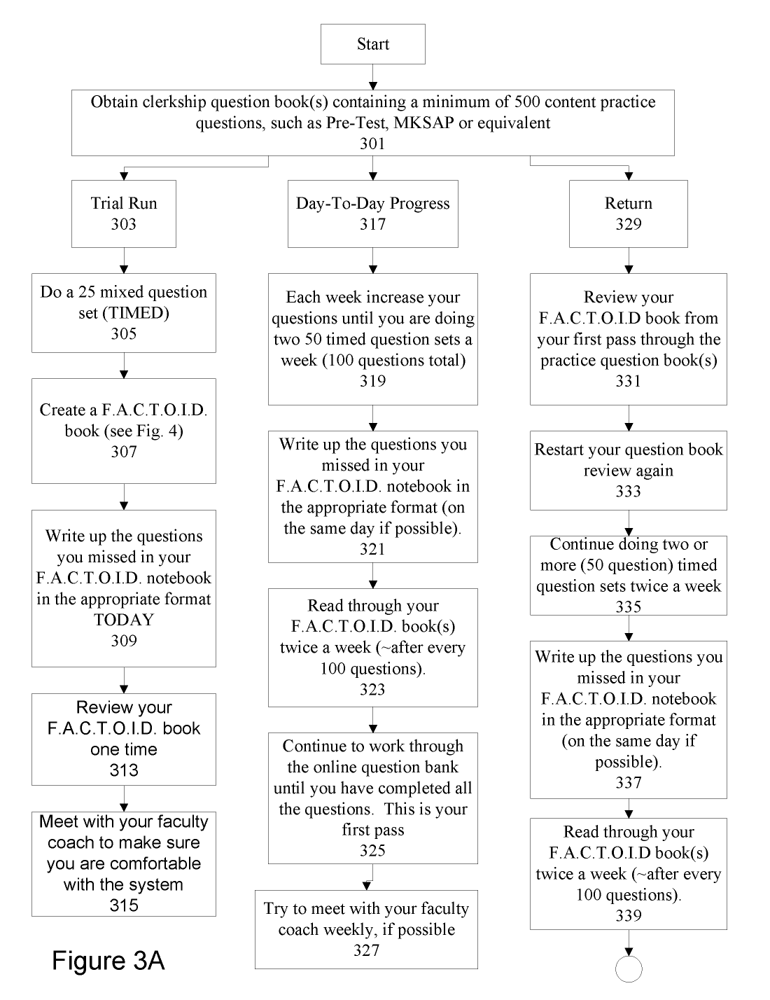

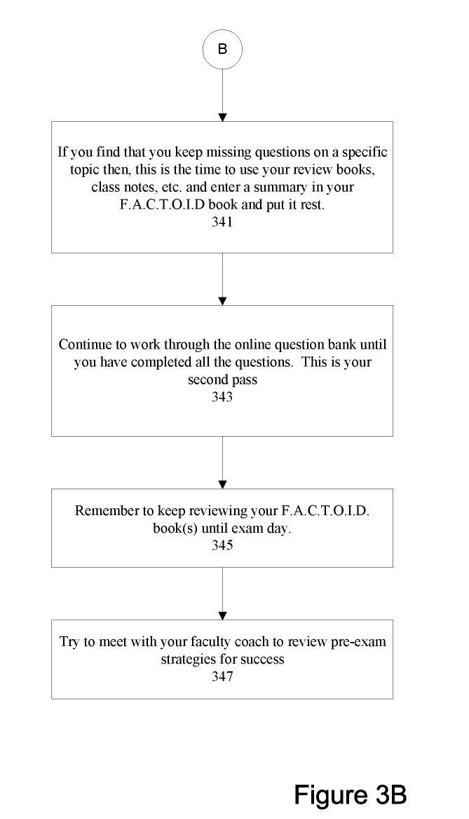

FIG. 3 is a flowchart illustrating an exemplary study method using review question books, in accordance with an embodiment of the present invention. In the present embodiment, the method begins at step 301 where the user obtains a review book or multiple review books comprising a minimum of 500 content practice questions. For the USMLE a content review question book is used; for clinical rotations a clerkship question book such as, but not limited to, Pre-Test, MKSAP, etc. may be used. In alternate embodiment the clerkship question book may be comprised of less practice questions depending on the book design, or former versions of clerkship question books may be used. The user then performs a trial run starting at step 303. For the trial run, the user answers 25 mixed questions in step 305. This step is timed to create test conditions; for example, without limitation, the user may have 30 minutes to answer all 25 questions (Approximately 1-1.5 minutes per question). In alternate embodiments the test run may comprise more or fewer questions. In the present embodiment, the user creates a F.A.C.T.O.I.D.® book in step 307, as described by way of example in accordance with FIG. 4. Then, in step 309, the user writes up the questions that were missed in the question set in the F.A.C.T.O.I.D.® book in the appropriate format, as described by way of example in accordance with FIG. 4. The user should ignore the score on the trial run as the score is not important at this point in the method. However, in some cases the user may want to look at this score so that he can track his progress later in the method. In step 313 the user reviews the F.A.C.T.O.I.D.® book one time preferably on the same day the trial run is performed. Then the user meets with a faculty coach in step 315 to make sure the user is comfortable with the system.

The method then proceeds to step 317, which begins the day-to-day progress of the method. In step 319 the user answers a question set twice a day, and each week the user increases the number of questions per question set until he is answering two timed question sets a week comprising 50 questions each, 100 questions total. This is the preferred number of questions to complete, and in alternate embodiments the user may perform more or fewer question sets a week with more or fewer questions. If a student is preparing for a USMLE test and using a content review question book, then the goal is the same as the online question set. Students studying for USMLE Step 1, usually have time to study with no other responsibilities (end of 2 year). This changes when they take step 2, they are usually studying while doing 4^{th} year electives. When studying for a clerkship exam (these exams come at the end of clinical rotation that changes every 8 weeks. These rotations are usually focused on a specific specialty, i.e, internal medicine, surgery, ob/gyn, pediatrics, psychiatry, and family & community medicine. The 3^{rd} year clerkship student has multiple responsibilities, i.e., taking care of patients, being on the wards as part of a team, didactic sessions, patient write-ups, on call, etc. They don't have time to do 100 questions/day. The goal of performing these question sets is to get through the practice question book(s) as quickly as possible. However, if the user has ample time to study or a limited time to study per day, the quick completion of the practice question book(s) may not be a priority. In step 321 of the present embodiment, the user writes up the questions missed in the F.A.C.T.O.I.D.® book in the appropriate format. This step is preferably performed on the same day that the question sets are answered if possible. The user reads through the F.A.C.T.O.I.D.® book(s) once or twice a week, for example, without limitation, after every 100 questions, in step 323. In alternate embodiments, the user may read through the F.A.C.T.O.I.D.® book more or less frequently. In the present embodiment, the user continues to work through the practice question book in step 325 until all of the questions have been completed. This completes the user's first pass. In step 327 the user tries to meet with the faculty coach weekly, if possible.

In step 329 the method begins a rerun of the practice questions book(s). In step 331 the user reviews the F.A.C.T.O.I.D.® book from the first pass through the practice question book(s). Then, in step 333, the user restarts the question book review from the beginning. The user continues doing two or more timed question sets comprising 50 questions twice a week in step 335 and writes up the questions missed in the F.A.C.T.O.I.D.® book in the appropriate format on the same day if possible in step 337. In alternate embodiments the user may perform more or fewer question sets per week with more or fewer questions. At this point in the present embodiment, the user should be missing fewer questions and therefore not having to write up as many questions in the F.A.C.T.O.I.D.® book. In step 339 the user reads through the F.A.C.T.O.I.D. book(s) about twice a week or about after every 100 questions. In alternate embodiments, the user may read through the F.A.C.T.O.I.D.® book more or less frequently. In the present embodiment if the user finds that he continues to miss questions on a specific topic, the user may use clerkship book(s) that he has been reading, didactic lecture notes or other reference material to enter a summary of the topic in the F.A.C.T.O.I.D.® book in step 341. This step may be skipped if the user does not seem to be missing questions on a specific topic regularly. The user continues to work through the practice question book(s) in step 343 until all of the questions have been completed. This is the second pass. If the user is running out of time and cannot work through all of the practice questions a second time in step 343, the user should preferably at least try to get through the previously missed questions from the first pass and write up missed questions. The user continues to review the F.A.C.T.O.I.D.® book(s) until exam day in step 345 and tries to meet with the faculty coach to review pre-exam strategies for success in step 347.

FIG. 4 is a flowchart illustrating an exemplary method for using a F.A.C.T.O.I.D.® book, in accordance with an embodiment of the present invention. The F.A.C.T.O.I.D.® book is preferably a spiral bound, single subject lined notebook. However, other types of notebooks or journals may be used such as, but not limited to, non-spiral notebooks, non-lined notebooks, multiple subject notebooks, bound journals, etc. The user should preferably choose an individual notebook cover design to distinguish his F.A.C.T.O.I.D.® book from others; however, the user may choose a plain or non-distinct notebook. There should be a lot of white space on the pages of the notebook to give the user ample space to write notes. The user may also need several black or blue ink pens with which to make these notes.

Referring to FIG. 4, the use of the F.A.C.T.O.I.D.® book begins at step 401. In step 401 when the user determines they have missed a question after completing the review question sets, the user rereads the question, answer and explanation. In step 403 the user jots down a few notes in an outline or single sentence form about the missed question in the F.A.C.T.O.I.D.® book. The user should not copy word for word the entire question, answer, or explanation. If the user has a chart or graph from didactic lectures or other learning environments or a special “pearl” from a resident or other type of instructor, the user can make a copy of this information and tape it into the F.A.C.T.O.I.D.® book in step 405. This step may be skipped if the user does not have such information. The user should not try to organize the concepts added to the F.A.C.T.O.I.D.® book by subject. Instead the user should just enter the concepts into the F.A.C.T.O.I.D.® book as they come. Also, the user should leave white space as they enter the concepts so they can come back and add notes later if needed. Also, the white space makes the page easier to read and the information on the page is less dense and more appealing to the eye. In step 407 the user continues to complete review question sets and as he completes the first and second passes, the F.A.C.T.O.I.D.® book fills up. If the F.A.C.T.O.I.D.® book becomes full, the user starts another book in step 409, remembering to include white space on the pages. In step 411, the user reviews the F.A.C.T.O.I.D.® book(s) as noted in accordance with FIGS. 2 and 3. The user preferably does not share the F.A.C.T.O.I.D.® book(s) with others, as they are uniquely his; however, there may be cases where the user may share the F.A.C.T.O.I.D.® book(s) for example, without limitation, in a group study session, or with his instructor. In alternate embodiments the F.A.C.T.O.I.D.® book may be referred to by a different name such as, but not limited to, a missed questions book, a topics to review book, an outline book, etc., and in other alternate embodiments, this book may have no specific name.

In alternate embodiments methods may be implemented that use both question banks and review question books. In these embodiments the user completes question sets from a question bank and from review books. This enables the user to complete more questions to get more practice and to answer questions on a computer and on paper. In some of these embodiments, the user may alternate between the question banks and the review books, and in other embodiments the user may move on to the review books once the question bank is exhausted or vice versa. The number and size of the question sets to be answered in these methods will vary depending on multiple factors including, but not limited to, whether the user is currently using the question bank or the review book, how many questions are in the question bank and review books combined, how long the actual test is, etc. If there is an area of weakness, the test taker may benefit from additional questions focused on a specific subject. An extra-focus exam can be created using an online question bank and/or a specific review book chapter or topic can be used for additional review.

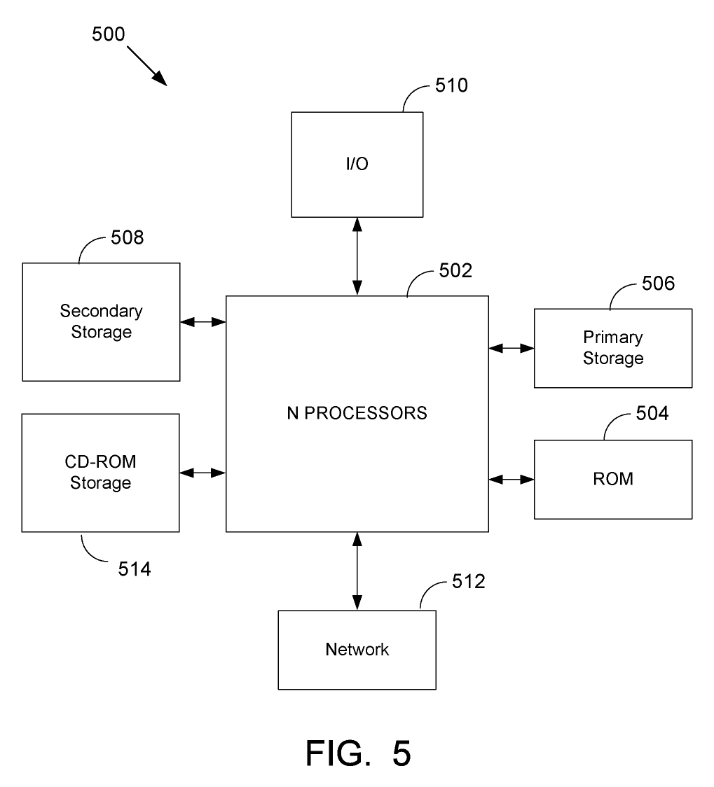

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU. CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Having fully described at least one embodiment of the present invention, other equivalent or alternative methods of studying for multiple-choice exams according to the present invention will be apparent to those skilled in the art. The invention has been described above by way of illustration, and the specific embodiments disclosed are not intended to limit the invention to the particular forms disclosed. For example, the particular implementation of the F.A.C.T.O.I.D.® book may vary depending upon the particular type of subject for which the user is studying. The F.A.C.T.O.I.D.® books described in the foregoing were directed to written implementations typically using lined paper; however, similar techniques are to provide different types of paper to accommodate various different subjects. For example, without limitation, a user studying for an exam comprising many mathematical or graphical questions such as, but not limited to, exams to become a professional engineer or architect may use a F.A.C.T.O.I.D.® book with graph paper. Implementations of the present invention using various different types of F.A.C.T.O.I.D.® books are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method for studying for a multiple-choice exam, the method comprising:
steps for obtaining access to a bank of review questions;
steps for accessing a set of questions from said bank;
steps for answering said questions of said set during a fixed time period;
steps for recording information about incorrectly answered questions;
steps for reviewing said recorded information;
steps for meeting with an exam coach; and
steps for repeating said steps for accessing, answering, recording, reviewing and meeting until all review questions have been answered.

2. The method as recited in claim 1, further comprising steps for, after all review questions have been answered, repeating said steps of accessing, answering, recording, reviewing and meeting until all review questions have been answered an additional time.

3. A method for studying for a multiple-choice exam, the method comprising steps of:
obtaining access to a bank of review questions for the exam;
accessing a set of N number of questions from said bank;
answering said N number of questions during a fixed time period;
recording information about incorrectly answered questions in an abbreviated format;
reviewing said recorded information;
meeting with an exam coach on a periodic basis; and
repeating said steps of accessing, answering, recording, reviewing, and meeting until all review questions have been answered.

4. The method as recited in claim 3, further comprising the step of after all review questions have been answered, repeating said steps of accessing, recording reviewing and meeting until all review questions have been answered an additional time.

5. The method as recited in claim 3, further comprising incrementing said N number of questions until a number of questions equals a desired number.

6. The method as recited in claim 3, wherein said review questions comprise mixed topics.

7. The method as recited in claim 3, wherein said information is recorded in at least one book.

8. The method as recited in claim 3, wherein said information further comprises notes pertaining to topics of said incorrectly answered questions.

9. The method as recited in claim 3, wherein said information further comprises a summary for a specific topic of repeatedly incorrectly answered questions.

10. The method as recited in claim 3, wherein said bank of review questions is obtained using a computing device.

11. The method as recited in claim 3, wherein said bank of review questions is obtained using at least one review book.

12. The method as recited in claim 3, wherein said bank of review questions is obtained using a computing device and at least one review book.

13. A system for studying for a multiple-choice exam, the system comprising:
a bank of review questions for the exam, said bank comprising a plurality of sets of questions that are accessed, one at a time, by a user answering questions in an accessed set during a determined time period;
a recording device for recording information about incorrectly answered questions in an abbreviated format where said user reviews said recorded information; and
an exam coach which said user meets on a periodic basis.

14. The system as recited in claim 13, wherein all of said review questions are answered by said user a plurality of times.

15. The system as recited in claim 13, wherein said review questions comprise mixed topics.

16. The system as recited in claim 13, wherein said recording device comprises at least one book.

17. The system as recited in claim 13, wherein said information further comprises notes pertaining to topics of said incorrectly answered questions.

18. The system as recited in claim 13, wherein said information further comprises a summary for a specific topic of repeatedly incorrectly answered questions.

19. The system as recited in claim 13, wherein said bank of review questions is accessed using a computing device.

20. The system as recited in claim 13, wherein said bank of review questions is accessed using at least one review book.

21. The system as recited in claim 13, wherein said bank of review questions is accessed using a computing device and at least one review book.

22. A system for studying for a multiple-choice exam, the system comprising:
means for accessing a plurality of sets of questions, one at a time, by a user answering questions in an accessed set during a determined time period;
means for recording information about incorrectly answered questions in an abbreviated format where said user reviews said recorded information; and
means for meeting with an exam coach on a periodic basis.

23. The system as recited in claim 22, wherein said questions comprise mixed topics.

24. The system as recited in claim 22, wherein said information further comprises notes pertaining to topics of said incorrectly answered questions.

25. The system as recited in claim 22, wherein said information further comprises a summary for a specific topic of repeatedly incorrectly answered questions.

26. A computer program product for studying for a multiple-choice exam, the computer program product comprising:
computer program code for obtaining access to a bank of review questions for the exam;
computer program code for accessing a set of questions from said bank;
computer program code for determining incorrectly answered questions in said set during a fixed time period;
computer program code for recording information about said incorrectly answered questions;
computer program code for reviewing said recorded information;
computer program code for meeting with an exam coach on a periodic basis;
computer program code for repeating said accessing, determining, recording, reviewing and meeting until all review questions have been answered; and
a computer-readable medium for storing the computer program code.

27. The computer program product as recited in claim 26, further comprising computer program code for, after all review questions have been answered, repeating said accessing, determining, recording, reviewing and meeting until all review questions have been answered an additional time.
